(19) United States
(12) Patent Application Publication
(10) Pub. No.: US 2012/0198083 A1
(43) Pub. Date: Aug. 2, 2012

(54) CLIENT DEVICE AND METHOD FOR FINDING AND BINDING TO A HOME CONNECTION

(75) Inventor: DAVID KILLIAN, LAKE WORTH, FL (US)

(73) Assignee: OPENPEAK, INC., BOCA RATON, FL (US)

(21) Appl. No.: 13/015,248

(22) Filed: Jan. 27, 2011

(51) Int. Cl. G06F 15/16

(52) U.S. Cl. 709/228

(57) ABSTRACT

In an embodiment, a client device scans to detect available remote connections using a network protocol. Upon detecting one or more available remote connections, the client device presents or transmits client credentials that are unique to the client device to the remote connections or devices until the client device finds a remote connection that accepts the credentials. The remote connection that accepts the credentials is stored as the home connection by client device, and the client device connects to the home connection. Once the home connection is set, the client device will no longer seek other connections, and will only attempt to re-connect with the home connection if the connection is lost.

### FIELD

The subject matter relates generally to data networks, and more particularly to locating and binding to a home connection such that affinity to the home connection is maintained subsequent to re-initialization events.

### BACKGROUND

Wireless interfaces have become increasingly popular for interconnecting devices to share, exchange, and transfer information. Wireless technology has been used for many different applications, including voice communication, wireless input devices (keyboards, mice), and so on. Wireless technology has become so widespread that wireless devices often operate in proximity to each other, both physically and in terms of radio range. In order to ensure that devices communicate with each other appropriately, they are typically bound to each other. Binding is a procedure where the wireless devices exchange identification information, use that information to establish a wireless radio link with each other, and thereafter automatically resume interoperation when they are within radio range of each other.

In order for devices to bind to each other they must be able to find each other. Some devices can constantly or periodically broadcast a beacon; other devices can use a “discoverable” mode where they broadcast a beacon for a period of time to allow other devices time to search for and find the broadcast beacon. While scanning for beacons or other radio connection transmissions, a device may detect beacon signals from several devices with which it can potentially connect. When multiple devices are detected, the device searching for a device with which to connect typically prompts a user to select one of the devices that has been detected. When a particular device is selected, the devices bind to each other, which is also sometimes referred to as pairing.

However, this sort of pairing/binding often requires user control of both devices. In situations where it would be beneficial or otherwise desirable to connect to devices over which the user does not have control, or complete control, alternate methods must be used. Therefore, a need for a means by which wireless devices can connect continues to exist.

### SUMMARY

An embodiment includes a method for initializing a home connection at a client device that can include scanning for available remote connection by the client device, using a wireless radio protocol. The client device commences generating a list of available remote connections as a result of performing the scan. The client device can commence automatically attempting to connect to at least one of the remote connections by transmitting a set of client credentials to one or more of the remote connections, wherein the client credentials are provided to the client device prior to the scan. The client device can commence determining that one of the remote connections has accepted the credentials responsive to presenting the credentials to the remote connection. The client device can commence setting the remote connection that accepted the credentials as a home connection in response to determining that the remote connection has accepted the client credentials. The client device can then connect to the home connection.

Another embodiment can include a client device having a controller, a transceiver that is operably coupled to the controller and is responsive to the controller and that is operable to transmit and receive radio signals, and firmware operably coupled to the controller. Firmware refers to instruction code that is stored in a non-volatile electronic memory directly addressable via a system or other bus by a processor or controller, and is distinguished from instruction code stored, for example, in magnetic media, optical media, or which is accessible through interfaces such as a universal serial bus (USB). Furthermore, firmware is generally accessed upon boot up of the device. The firmware can contain instruction code that is executed by the controller that causes the client device to scan for available remote connections, present client credentials to at least one available remote connection, determine that a remote connection has accepted the client credentials, set the remote connection that has accepted the client credentials as a home connection, and establish a connection with the home connection.

Another embodiment can include a network connection system that has at least one remote connection operable to provide a wireless connection, and a client device. The client device scans to detect one or more remote connections and upon detecting remote connections, it presents client credentials to each detected remote connection. The client device can then determine if the remote connection accepts the credentials. Upon a remote connection accepting the credentials, the client device sets the remote connection that accepted the credentials as a home connection, and connects to the home connection.

Another embodiment includes a method for pre-authorizing client device connections at a remote connection. The method can commence by provisioning a remote connection with credentials corresponding to client credentials that will be accepted by the remote connection. A client device can then detect the remote connection. The client device has client credentials prior to detecting the remote connection. The client device can then present the client credentials to the remote connection in response to detecting the remote connection. The method can then proceed by determining that the client credentials presented by the client device correspond to the credentials at the remote connection in response to presenting the client credentials. The client device can then commence setting the remote connection as a home connection in response to determining that the client credentials presented by the client device correspond to the credentials at the remote connection. Upon a re-initialization event of the client device, the client device attempts to re-connect with the home connection before scanning for any other remote connection.

### BRIEF DESCRIPTION OF THE DRAWINGS

There are shown in the drawings, embodiments which are presently preferred, it being understood, however, that the subject matter is not limited to the precise arrangements and instrumentalities shown.

FIG. 1 shows a block schematic diagram of a client device in accordance with an embodiment;

FIG. 2 shows a system diagram of a wireless connection system in accordance with an embodiment;

FIG. 3 shows a flow chart diagram of a method of connecting in a wireless connection system, in accordance with an embodiment; and

FIG. 4 shows a flow chart diagram of a method of connecting in a wireless connection system, in accordance with an embodiment.

### DETAILED DESCRIPTION

While the specification concludes with claims defining features that are regarded as novel, it is believed that the claims will be better understood from a consideration of the description in conjunction with the drawings. As required, detailed embodiments are disclosed herein; however, it is to be understood that the disclosed embodiments are merely exemplary. Therefore, specific structural and functional details disclosed herein are not to be interpreted as limiting, but merely as a basis for the claims and as a representative basis for teaching one skilled in the art to variously employ the present subject matter in virtually any appropriately detailed structure. Further, the terms and phrases used herein are not intended to be limiting but rather to provide an understandable description.

Embodiments include a method, device, and system for a client device to find a home connection. The home connection is provisioned with unique credentials that correspond to unique credentials of the client device. The client device initially commences a scan to find available remote connections. The client device transmits or presents its unique client credentials to remote connections that have been found as a result of the scan. Each remote device, upon receiving the client credentials, checks to see if it has corresponding credentials. If not, the remote connection rejects the client device. If the remote connection has been provisioned with the client credentials, the remote connection indicates acceptance of the client credentials, and the client device sets the accepting remote connection to a home connection. Once set, the client device only attempts to re-connect with the home connection should it become disconnected, and does not scan or search for other remote connections.

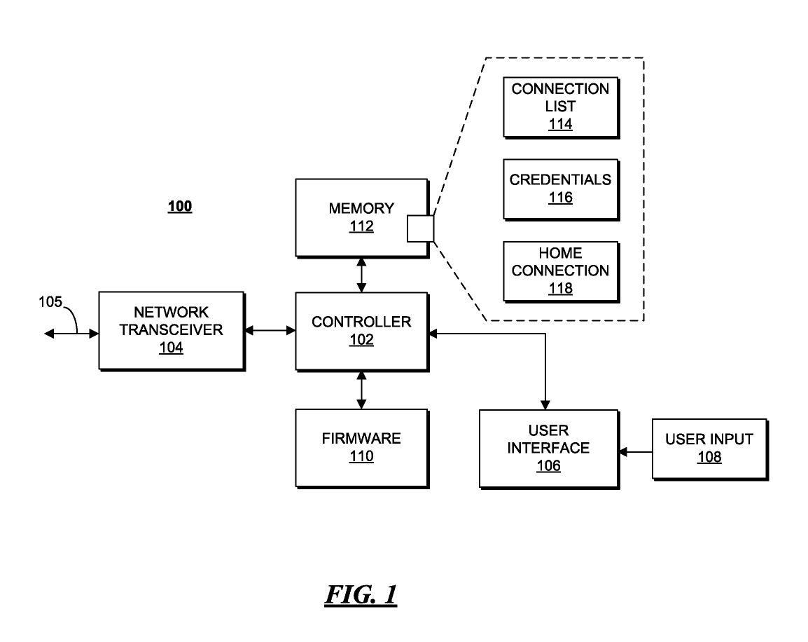

Referring to FIG. 1, there is shown a block schematic diagram of a client device 100 in accordance with an embodiment. The client device 100 is a device that communicates with a home connection, and can provide a user interface to allow a user to use data and services provided by or through the home connection. The client device 100 as shown here is a generalized embodiment of a client device as contemplated with regard to the present subject matter and contains both hardware and software elements. It can be realized in a variety of configurations including as a substantially stand-alone device or as a portion of a larger, more sophisticated device. The client device 100 can be implemented as a network adapter, or as a device incorporating such an adapter. The client device 100 includes a controller 102 that controls operation of the client device 100. The controller 102 can be a microprocessor or microcontroller that operates according to instruction code designed in accordance with the teachings of the present disclosure. The controller 102 interfaces with a network transceiver 104 that accesses or connects to other devices using a network medium 105. The network transceiver 104 can be a wired or a wireless transceiver. The network transceiver 104 includes circuitry and components for formatting signals for transmission into the network medium, and can include frequency generation control, timing, modulation and demodulation, amplification, filtering components, and so on, as is well known. The network transceiver 104 includes a transmitter for transmitting signals to other devices, and a receiver for receiving signals from those devices over the network medium 105. The signals can conform to a standardized network protocol or air interface, which specifies network medium characteristics. If the network medium 105 is a wireless medium, such characteristics can include signal or carrier frequency, channel frequency bandwidth, modulation type, channel bandwidth, timing, and so on. In one non-limiting embodiment, the network medium can be a wireless air interface that is substantially in conformance with an interface specified by the Institute of Electrical and Electronic Engineers (IEEE) working group for specification 802.15.

The controller 102 can be further interfaced with a user interface 106, which allows a user to interact with and operate the client device 100. The user interface 106 can be as elaborate as a graphical display for displaying information and a keypad or other buttons for receiving information and commands and other input 108 from a user, or it can be as simple as a communication bus over which information can be received and transmitted, such as a universal serial bus (USB).

The controller 102 operates according to instruction code that can be stored in firmware 110. The firmware 110 is stored in a machine readable storage medium, which is non-transitory, meaning that information stored therein persists after power is removed from the memory, such as by virtue of the state of semiconductor components of the memory that can be electrically transitioned from an “on” state to an “off” state, and vice versa, corresponding to a logical “1” or “0.” The memory can be a read only memory (ROM) or a re-programmable memory such as an electrically erasable programmable read only memory (EEPROM), or any other such persistent memory, and can be interfaced or operably coupled to the controller 102 via a conventional bus.

Generally, upon the client device 100 turning on or being powered up, the controller 102 fetches instructions from the firmware 110 and begins executing the instructions. The firmware 110 can include a protocol stack for implementing network and data interface operations in conformance with a standardized protocol. Examples of such protocols can include IEEE standard 802.15, which is known in industry by the trade name “ZigBee.”

In the process of executing instructions upon powering up, the controller 102, responsive to the firmware 110, can establish certain data structures in a memory 112. The memory 112 is also a machine readable storage medium and can include both volatile and non-volatile memory such as random access memory (RAM), flash memory, and other re-usable memory elements. In addition to runtime variables and other data structure instantiations that can be contained in the memory 112, the memory 112 can also contain a connection list 114, client credentials 116, and a home connection identification 118. The client credentials 116 identify the particular client device 100 and are substantially unique to the client device 100. Each client device has its own unique client credentials. The client credentials 116 should be present in the client device 100 before the client device 100 attempts to find a home connection. In one arrangement, the client credentials 116 are stored in the client device 100 upon manufacture of the client device 100. The credentials 116 can be an identifier or a serial number of the client device 100, a unique key, or other suitable means to authorize and/or authenticate the client device 100 where the client credentials 116 are unique to the client device 100.

In operation, the client device 100, upon powering up, determines if a home connection 118 has been set. When no home connection 118 is indicated, the client device 100 begins scanning to detect available remote connections using the network medium 105. The remote connections are provided by remote devices or networks that also operate using the network medium 105. Each remote connection can allow the client device 100 to present the client credentials 116 to the remote connection as the client device 100 attempts to find a remote connection that will accept the client credentials 116. Thereafter, the remote connection that accepted the client credentials 116 will allow the client device to have additional access and a permanent home connection. The remote connection can be a stand-alone device, or it can operate as a gateway to further network connections, or it can be a network. In at least one embodiment, the remote connection is not a wireless router or access point. The remote connections, therefore, use the network medium 105 that is used by the client device 100. When the network medium 105 is a conventional wired network medium, the client device 100 can use conventional network procedures to discover available remote connections. Once the client device 100 has found a home connection, it avoids attempts to find or connect to any other remote connection. Upon being disconnected from the home connection, the client device 100 only attempts to resume the home connection, and does not scan or otherwise search for other connections.

When the network medium is a radio network medium, the remote connection should be within radio range of the client device 100. Scanning the radio network medium is performed by tuning the transceiver 104 to various defined channels. Channels can be defined in both frequency and time, as well as by modulation method. The client device 100 can tune its receiver to a channel and determine whether there is activity on the channel using a passive mode, or, in an active mode, transmit an interrogation beacon to determine if there is a response from any remote connection, indicating a potentially available remote connection.

Each available remote connection can be noted in a remote connection list 114. The remote connection list 114 is used to record the channel or other network location for each available remote connection found, and can include additional information such as an identifier of the remote connection. At least some of the available remote connections are potential home connections. To find its home connection, the client device 100 presents its client credentials 116 to the available remote connections until, for example, one of the available remote connection accepts the client credentials 116 and becomes the home connection 118. The home connection 118 allows the client device 100 to have additional and continued access to the device or network providing the home connection 118. Upon the client device 100 being re-initialized, such as after a power cycle, the client device 100 can first examine the contents of the memory space for the home connection 118. If there is an indication of a home connection 118 there, such as an identifier and/or channel, the client device 100 automatically attempts to reconnect with the home connection 118 without scanning for any other connection.

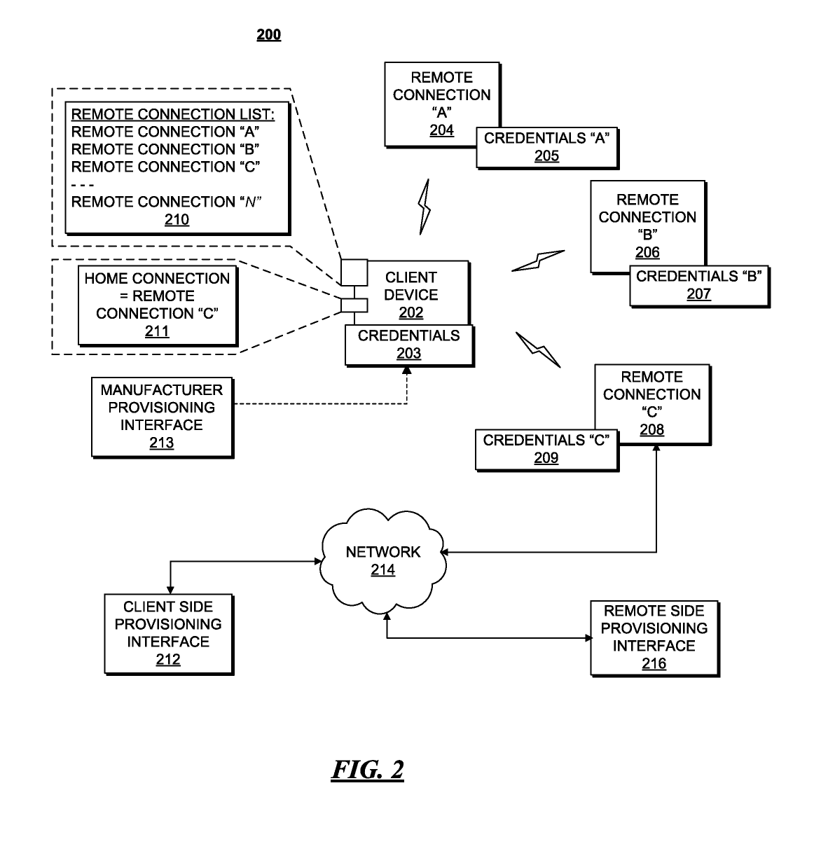

FIG. 2 shows a system diagram of a wireless connection system 200 in accordance with an embodiment. A client device 202 can be substantially similar to the client device 100 of FIG. 1, and can operate in an environment with multiple remote connections, such as remote connection “A” 204, remote connection “B” 206, and remote connection “C” 208. Each remote connection 204, 206, 208 can be a stand-alone device, or it can be a connection point for a network, and permits a network connection, such as a wired or wireless network connection, that allows each remote connection 204, 206, 208 to receive client credentials from client devices such as client device 202. The client device 202 has its client credentials 203 before it begins scanning to find or locate available remote connections, and before the client device 202 attempts to find a home connection. The client credentials 203 are unique to the client device 202, meaning that no other client device will have the same client credentials 203. Furthermore, the device or network that is intended to become the client device's home connection is also provided with credentials that correspond to the client credentials 203. The client credentials 203 are generally provided at the time of manufacture of the client device 202; however, such credentials may be provided at any other suitable time. Likewise, before a remote connection 204, 206, 208 will allow a client device to connect and bind to it, it should be provided with credentials that correspond to client credentials 203. Since each client device 202 has substantially unique client credentials 203, if a remote connection is to allow multiple client devices 202 to connect to it, it should be pre-provisioned with credentials for each client device 202 that will connect with it.

The client credentials 203 can be stored in a memory of the client device 202, either as re-programmable data or hard coded data. Upon powering up or otherwise being initialized, the client device 202 commences finding a home connection. To find a home connection the client device 202 commences attempting to make network connections with remote connections. In one embodiment, the client device 202 commences scanning known channels to detect remote connections operating on the scanned channel. While scanning, the client device 202 can generate a remote connection list 210, which can indicate all available remote connections found while scanning or otherwise surveying the available network medium for available remote connections. In the present example, client device 202 finds remote connections A-C, which are remote connections 204, 206, and 208, respectively. Remote connections 204, 206, 208 are provisioned with credential information 205, 207, 209, respectively. In order for the client device 202 to connect to one of the remote connections 204, 206, 208, one of them should be provisioned with credentials that correspond to the client credentials 203 used by the client device 202.

Client device 202 processes the remote connection list 210 by initiating communication with the next remote connection on the list, starting with a first remote connection, and transmitting the client credentials 203 to the remote connection. Each remote connection, upon receiving the client credentials 203, compares the received client credentials 203 with credentials 205, 207, 209, depending on which remote connection 204, 206, 208 is communicating with the client device 202, to determine whether there is an appropriate correspondence. Each remote connection 204, 206, 208 can check to see if the client credentials 203 are identical, or whether they indicate some other appropriate correspondence, such as using an appropriate cryptographic cipher key, hash, certificate, or other such means, with the respective credentials 205, 207, 209. The client credentials 203 are substantially unique to the particular client device 202. The client credentials can be an alphanumeric sequence that is sufficiently long enough that the chances two client devices in proximity to each other having the same client credential would be negligible.

When a remote connection 204, 206, 208 indicates acceptance of the credentials 203 from the client device 202, the client device 202 sets the accepting remote connection to be the home connection 211 for the client device 202. In the present example, remote connection 208 accepts the client credentials 203 and becomes the home connection for the client device 202. As used here, the term “home connection” refers to the device or network that is provisioned with credential information corresponding to the client credentials 116, and which communicates with the client device 202 to provide data and services to the client device 202. Thereafter, the client device 202 maintains affinity with the home/remote connection 208 and will only connect to the home/remote connection 208, unless reset. As used here, there term “affinity” refers to the operation of the client device 202 subsequent to setting the home connection where the client device does not attempt to connect to any other remote connection, even upon a re-initialization event. Upon being re-initialized, such as after a power cycle (being powered off and back on), or due to signal degradation, the client device 202 will automatically attempt to re-connect with the home/remote connection 208 without searching for other connections. As used here the term “re-initialized” refers to the client device 202 losing communication with the home connection 208, and attempting to re-connect with the home connection 208, which is distinguished from being “reset.” When the client device 202 is reset, a user or other person must take an affirmative action to cause the client device 202 to erase its home connection setting, and start searching for a new home connection. In a re-initialization event, however, the home connection remains set and the client device 202 attempts to re-connect with the previously set home connection, and does not attempt to search for or connect to any other remote connection. Upon re-connecting with the home connection 208, the home connection 208 may require re-presentation of the client credentials 203, or it may simply recognize some other parameter such as a media access (MAC) address or unit identifier or some other identifier provided when the client device 202 initiates re-connection.

In one arrangement, the client credentials 203 are provided to the client device upon manufacture, although other suitable techniques for providing the client credentials 203 may be employed. The client credentials 203 can be provided to the client device 202 by a manufacturer provisioning interface 213, which can include, for example, a graphical user interface presented on a personal computer that is connected to the client device 202. Alternatively, the client device can be manufactured with a computer readable storage component, such as a ROM, that contains client credentials 203. In alternative embodiments, the client credentials can be entered into the client device by interface means of the client device 202. To pre-provision a remote device with credential information corresponding to the client credentials, a client side provisioning interface 212 can used to transmit the credential information to the remote connection. The client side provisioning interface 212 allows a customer or other operator of the client device to provision the remote connection, and can be, for example a graphical user interface or web page. Alternatively, the remote connection can be provisioned by a remote side provisioning interface 216 operated by some authority or other operator of the remote connection. Both the client side provision interface 212 and remote side provisioning interface 216 can communicate with the remote connection via a network 214, which can include the Internet.

In at least one embodiment, as an example, remote connection 208 can be a smart energy meter or meter network. The owner of the premises serviced by the smart energy meter (remote connection 208) can access an Internet web service provided by the organization responsible for providing the energy to the premises, and access a service via network 214 that will provision the smart energy meter with unique credential information corresponding to client credentials 203 so that the remote connection 208 with accept the client credentials 203 when presented by client device 202, thereby allowing client device 202 to set the smart energy meter as a home connection. Accordingly, provisioning remote connection 208 sets credentials 209 to correspond to client credentials 203.

Alternatively, the client side provisioning interface 212 can allow a user to directly provision a remote connection, such as remote connection 208, using a local connection from client side provisioning interface 212. For example, a user can use a general purpose computer having a universal serial bus (USB) to connect to remote connection 208 and provide the credentials 209 to the remote connection 208. In another alternative, a remote party, using a remote provisioning interface 216, can connect the remote connection 208 and provision the credentials 209 that will correspond to the client credentials 203 used by client device 202, such as via the network 214.

The remote connections 204, 206, 208 are provisioned with credentials 205, 207, 209 to pre-authorize certain client devices 202 to join the remote connections if the client devices 202 present client credentials 203 that correspond to the credentials 205, 207, or 209. Upon provisioning the remote connection 208 with credentials 209, the remote connection 208 can commence operating in a joinable mode, where it will broadcast a signal to allow client devices 202 to find or discover it. The joinable mode can be terminated once the client device 202 connects to the home/remote connection 208. Alternatively, the remote connection can remain in a discoverable mode while operating. Once connected, continuing with the present example, the remote connection 208 can then provide energy usage information to a user of the client device 202. In alternative arrangements, the provisioning can be performed by other entities, such as a customer service representative of the energy company. Numerous variations of provisioning arrangements will occur to those skilled in the art.

The client device 202, in seeking a home connection, can process the connection list 210 in several different manners. The client device 202 can scan the network medium at various network addresses (such as after broadcasting a beacon to determine which remote connections are available) or scan every known channel for remote connections, generating the remote connection list 210 while doing so. Upon scanning every channel, the client device 202 can start with, for example, the first entry on the list and present the client credentials 203 to remote connections on the list until one accepts the client credentials 203. Alternatively, the client device 202, upon detecting a remote connection, can present the client credentials 203 to the detected remote connection immediately upon detection of the remote connection. The remote connection list 210 can then be used to keep track of which remote connections have been tried so as to avoid duplicate attempts with remote connections that have rejected the client credentials 203.

Although the present example generally contemplates wireless interfaces, the client device 202 can also connect to a wired network and seek out remote connections over the wired network with which to bind. One or more of the remote connections 204, 206, 208 can be likewise accessed by a wired network using wired network protocols, and presented with the client credentials 203 by the client device 202. A remote connection accepting the client credentials 203 can then allow the client device 202 further access to other functions facilitated or provided by the remote connection.

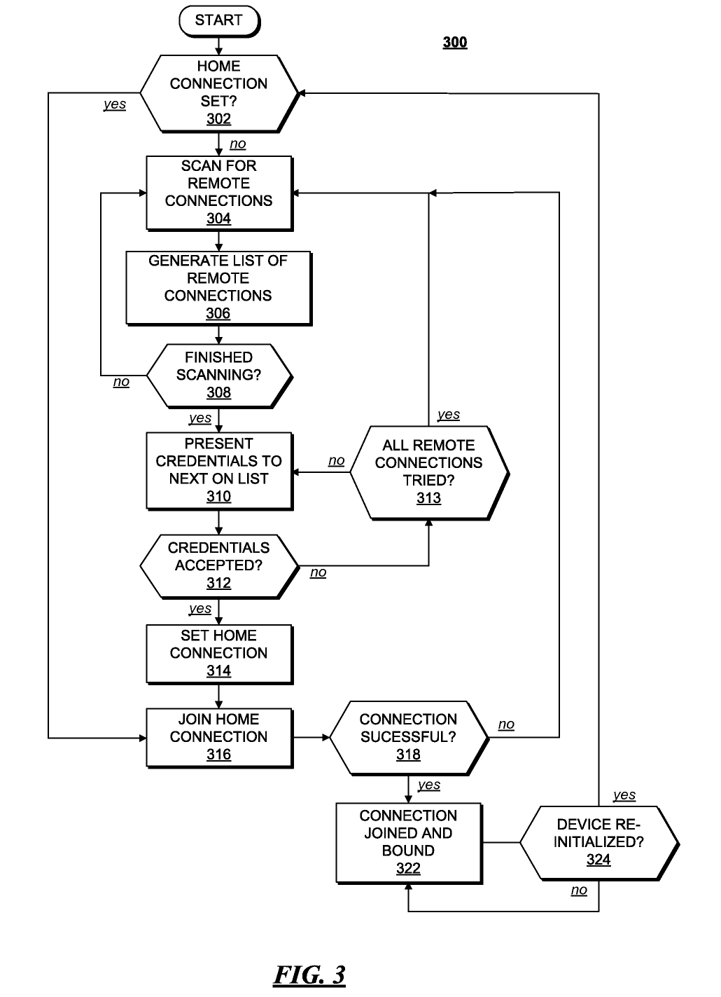

FIG. 3 shows a flow chart diagram of a method 300 of connecting in a wireless connection system, in accordance with an embodiment. The present method 300 is one alternative method that can be implemented according to exemplary teachings of the present disclosure. The method 300 illustrated here may be applicable to the embodiments described above in relation to FIGS. 1-2, but it is understood that the method 300 can be carried out with other suitable systems and arrangements. Moreover, the method 300 may include other steps that are not shown here, and in fact, the method 300 is not limited to including every process shown in FIG. 3. The processes that are illustrated here as part of the method 300 are not limited to the particular chronological order in which they are presented for the present example, either.

The method 300 is implemented by a client device such as client device 202 shown and described in FIG. 2. At the START of the method 300, the client device 202 is powered on or otherwise initialized. Upon being initialized, the client device 202 can first determine if a home connection 211 has already been set 302. If a home connection 211 has been set, such as by a previous iteration of the present method 300, the client device 202 simply joins the home connection 316 without attempting to join or scan for any other connection. If the home connection 211 has been set, but is not found initially, the client device 202 continues to attempt to join the home connection 211 and can wait until the home connection 211 becomes available. If no home connection has been set, the client device 202 commences scanning for available remote connections 304. The client device 202 can be a client with client credentials 203 prior to this point, or the client device 202, prior to commencing the scan, can, for example, prompt the user of the client device 202 to provide the client credentials 203, such as by a user interface 106 of the client device 202.

The client device 202 searches available channels or network locations to determine if a remote connection is presently available to which the client device 202 can potentially connect with as a home connection. While scanning for remote connections, the client device generates a list 210 of available remote connections 306, and can scan until all available network locations or channels have been queried or scanned 308. Once the connection list 210 has been generated, the client device 202 commences processing the list 210 by presenting 310 (transmitting) its client credentials 203 to the next remote connection indicated on the connection list 210 and determines whether the remote connection has accepted 312 the client credentials 203. If the client credentials 203 are rejected, the method 300 proceeds to determine 313 if all remote connections found during the scan 304 have been tried. If not, then the method proceeds to present the client credentials 203 to the next remote connection on the list 210. If it is determined 313 that all remote connections found during the scan 304 have been tried, the method can proceed to repeat the scan and continue scanning 304 and presenting 310 until a remote connection accepts the client credentials 203.

Once a remote connection accepts the client credentials 203, the client device 202 sets its home connection 211 to the remote connection that has accepted 314 the client credentials 203. The client device 202 can then attempt to join the home connection 316, meaning that the client device 202 can then attempt to commence an ongoing communication with the home connection that allows additional access to the remote connection. If the connection attempt is successful 318, the client device 202 will then be connected and bound 322 to the remote connection that accepted the client credentials 203 as a home connection. As an alternative, rather than setting the home connection 314 before successfully joining the remote connection, the client device 202 can wait until it has successfully joined or connected with the remote connection at 322 before setting it as the home connection.

Once connected, the client device 202 may be re-initialized 324, which results in the method being substantially repeated, except that since the home connection has been set, the client device 202 will automatically proceed to attempt to join the home connection 316 without scanning for other remote connections.

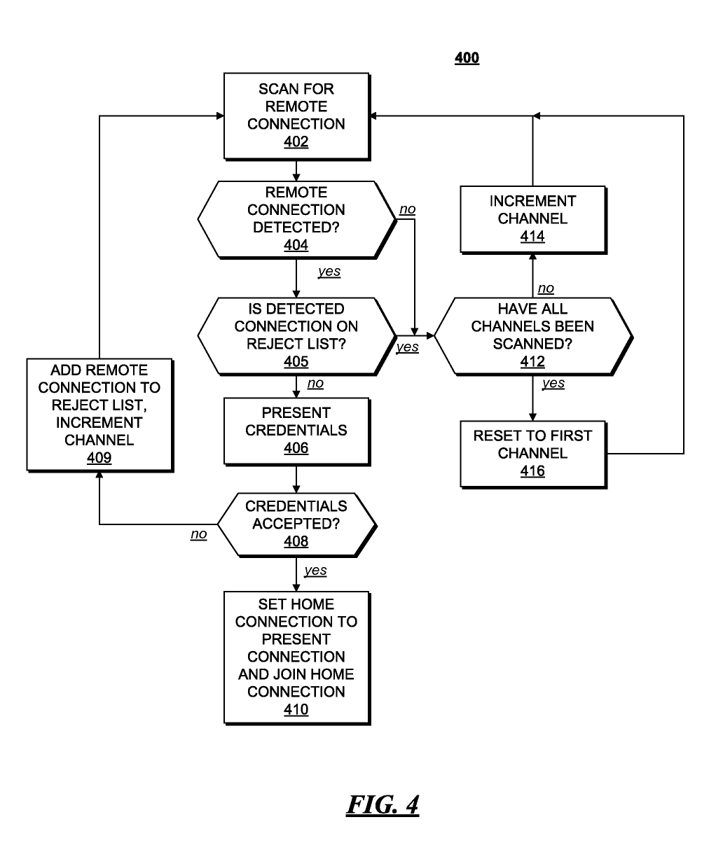

FIG. 4 shows a flow chart diagram of a method 400 of connecting in a network connection system, in accordance with an embodiment. The method 400 illustrated here may be applicable to the embodiments described above in relation to FIGS. 1-2, but it is understood that the method 400 can be carried out with other suitable systems and arrangements. Moreover, the method 400 may include other steps that are not shown here, and in fact, the method 400 is not limited to including every process shown in FIG. 4. The processes that are illustrated here as part of the method 400 are not limited to the particular chronological order in which they are presented for the present example, either.

As an alternative to scanning all available channels or network locations first and generating a connection list, the client device 202 can, upon detecting an available remote connection, immediately present the client credentials 203 to the detected remote connection and determine if the client credentials 203 are accepted before continuing with further scanning Accordingly, the client device 202 commences scanning 402 for an available connection. Initially, the client device 202 can start the scanning at a pre-selected channel. Upon scanning a given channel, the client device 202 determines 404 whether a remote connection has been detected. Since the process of scanning can be iterative, the client device checks 405 a rejection list to determine whether a detected remote connection has already rejected the client device 202. If the detected remote connection is not on the rejection list, the client device 202 then presents or transmits 406 its client credentials to the detected remote connection. The client device 202 can then determine whether the client credentials 203 have been accepted or rejected 408. If the client credentials 203 are not accepted, the client device 202 adds the rejecting remote connection to a rejection list 409, increments or otherwise changes to another channel, and resumes scanning 402. The rejection list allows the client device 202 to avoid repeated attempts with remote connections that have previously rejected the client device's 202 attempt to connect to it. When the client credentials are accepted, as indicated, for example, by an acknowledgement from the remote connection, the client device 202 sets the remote connection that has accepted the client credentials as its home connection 410. Information about the home connection is stored in the client device, and can include a channel, an identifier of the home connection, an encryption key to be used in communication with the home connection, and so on. Once a home connection has been set, the client device 202 does not scan for other connections. Upon losing connectivity with the home connection, the client device only attempts to re-connect with the home connection.

While scanning 402 for a connection, the client device 202 can determine that no remote connection has been found at 404. When no remote connection has been found, the client device 202 can then determine if all available channels have been scanned during the present iteration 412. If more channels remain to be scanned, the client device 202 can increment or otherwise change to the next channel 414 and continue scanning 402. If all channels have been scanned during the present iteration and no home connection has been found, the client device 202 can reset to the initial channel 416 and commence another iteration of the scanning process.

This description can be embodied in other forms without departing from the spirit or essential attributes thereof. Accordingly, reference should be made to the following claims, rather than to the foregoing specification, as indicating the scope of the invention.

What is claimed is:

1. A method for initializing a home connection at a client device, the client device having unique client credentials, the home connection having been provisioned with credentials corresponding to the client credentials, the method comprising:
scanning for available remote connections, by the client device, using a network protocol;
generating a list of available remote connections as a result of the scanning;
automatically attempting to connect to at least one of the remote connections by transmitting the client credentials to at least one of the remote connections;
determining that one of the remote connections has accepted the client credentials responsive to attempting to connect;
setting the remote connection that accepted the client credentials as the home connection in response to determining that the remote connection has accepted the client credentials; and
connecting to the home connection.

2. The method of claim 1, further comprising:
subsequent to setting the home connection, re-initializing the client device; and
automatically resuming the home connection without attempting to scan for any other remote connection.

3. The method of claim 1, wherein scanning for available remote connections comprises scanning using a wireless network protocol substantially in conformance with an Institute of Electrical and Electronic Engineers (IEEE) 802.15 specification.

4. The method of claim 1, wherein the client credentials are provided to the client device as an alphanumeric sequence.

5. The method of claim 4, wherein provisioning the home connection comprises provisioning a smart energy meter.

6. The method of claim 4, wherein provisioning the home connection causes the home connection to operate in a joinable mode.

7. The method of claim 6, further comprising ending the joinable mode upon the client device connecting to the home connection over the wireless connection.

8. The method of claim 1, further comprising prompting a user of the client device to provide the client credentials to the client device before scanning.

9. A client device which connects to a home connection and maintains affinity with the home connection, the home connection having been provisioned with credentials corresponding to unique client credentials of the client device, the client device comprising:
a controller;
a transceiver that is operably coupled to the controller and is responsive to the controller and that is operable to transmit and receive network signals;
firmware operably coupled to the controller that contains instruction code that is executed by the controller that causes the client device to scan for available remote connections, present the client credentials to at least one available remote connection, determine that a remote connection has accepted the client credentials, set the remote connection that has accepted the client credentials as the home connection, and establish a connection with the home connection.

10. The client device of claim 9, wherein the client device generates a list of remote connections in response to the scan for available remote connections, and processes the list by presenting the client credentials to the available remote connections sequentially until the client credentials are accepted by one of the available remote connections.

11. The client device of claim 9, wherein the client device, upon detecting an available remote connection, presents the client credentials to the available remote connection, and generates a list of remote connections that have rejected the client credentials.

12. The client device of claim 9, wherein the client device, subsequent to the home connection being set and subsequent to a re-initialization event, automatically resumes the home connection without scanning for other connections.

13. The client device of claim 9, wherein the client credentials are provided to the client device by a user of the client device responsive to a prompt provided by the client device to the user of the client device, the prompt being provided before the client device scans for available remote connections.

14. The client device of claim 9, wherein the transceiver transmits and receives radio signals using a protocol substantially in conformance with an Institute of Electrical and Electronic Engineers (IEEE) 802.15 specification.

15. A network connection system, comprising:
at least one remote connection operable to provide a network connection;
a client device operable to scan for remote connections and present client credentials to at least one of the remote connections, and upon a remote connection accepting the client credentials, the client device sets the remote connection that accepted the client credentials as a home connection and connects to the home connection.

16. The network connection system of claim 15, wherein the client device and each of the at least one remote connection communicate using a wireless protocol substantially in conformance with an Institute of Electrical and Electronic Engineers (IEEE) 802.15 specification.

17. The network connection system of claim 15, wherein the client device, generates a list of remote connections and processes the list by presenting the client credentials to each remote connection on the list until the client credentials are accepted.

18. The network connection system of claim 15, wherein the client device, upon detecting a remote connection, immediately presents the client credentials to the remote connection to determine if the remote connection will accept the client credentials.

19. The network connection system of claim 15, wherein the client device is operable to prompt a user to provide the client credentials to the client device before the client device scans for the at least one remote connection.

20. The network connection system of claim 15, further comprising a provisioning interface that is operable to provision the home connection to accept the client credentials presented by the client device.

21. A method for pre-authorizing client device connections for a remote connection that has been provisioned with credentials corresponding to client credentials, the method comprising:
detecting the remote connection, performed by a client device, the client device having client credentials that have been provided to the client device prior to detecting the remote connection;
presenting the client credentials to the remote connection by the client device in response to detecting the remote connection;
determining that one of the remote connections has accepted the client credentials responsive to presenting the client credentials; and
setting the remote connection as a home connection at the client device in response to determining that the client credentials presented by the client device correspond to the credentials at the remote connection, wherein upon a re-initialization event of the client device the client device attempts to re-connect with the home connection before scanning for any other remote connection.

22. The method of claim 21, wherein the scanning is performed over a wireless radio air interface substantially conforming to an Institute of Electrical and Electronic Engineers (IEEE) 802.15 specification.

23. The method of claim 21, wherein detecting the remote connection occurs while scanning for available remote connections.

24. The method of claim 21, wherein the client credentials are provided to the client device by a manufacturer provisioning interface.
